(19) United States
(12) Patent Application Publication
(10) Pub. No.: US 2025/0391599 A1
(43) Pub. Date: Dec. 25, 2025

(54) INDUCTOR, AND METHOD OF MANUFACTURING INDUCTOR

(71) Applicant: Murata Manufacturing Co., Ltd., Kyoto-fu (JP)

(72) Inventor: Norihiro NAKAI, Nagaokakyo-shi (JP)

(73) Assignee: Murata Manufacturing Co., Ltd., Kyoto-fu (JP)

(21) Appl. No.: 19/310,335

(22) Filed: Aug. 26, 2025

Related U.S. Application Data
(63) Continuation of application No. PCT/JP2024/021800, filed on Jun. 17, 2024.

(30) Foreign Application Priority Data
Sep. 25, 2023 (JP) 2023-160725

(51) Int. Cl. H01F 27/28; H01F 1/147; H01F 27/29; H01F 41/10

(52) U.S. Cl. CPC H01F 27/2804; H01F 1/14766; H01F 27/292; H01F 41/10; H01F 2027/2809

(57) ABSTRACT

An inductor which has a reduced amount of Si component deposited and includes a coil conductor having a reduced amount of pores generated therein, and a method of manufacturing the inductor. The inductor includes a base body internally including a coil conductor and containing a metal magnetic particle and a resin; and outer electrodes that are provided on the base body and are connected to the coil conductor. The metal magnetic particle is composed of a metal particle containing Fe and Si, and an oxide layer provided on the surface of the metal particle. A peak value of a Si concentration in the oxide layer is less than or equal to twice a Si concentration at a predetermined position in an internal portion of the metal particle, and the coil conductor has a pore proportion of 10% or less.

### CROSS-REFERENCE TO RELATED APPLICATIONS

This application claims benefit of priority to International Patent Application No. PCT/JP2024/021800, filed Jun. 17, 2024, and to Japanese Patent Application No. 2023-160725, filed Sep. 25, 2023, the entire contents of each are incorporated herein by reference.

### BACKGROUND

### Technical Field

The present disclosure relates to an inductor and a method of manufacturing the inductor.

### Background Art

Japanese Unexamined Patent Application Publication No. 2018-6411 discloses a multilayer coil component including: a base body containing a soft magnetic metal material (e.g., an Fe (iron)-Si (silicon) alloy or an Fe—Si—Cr (chromium) alloy); and a coil disposed in the base body, in which the coil includes a plurality of internal conductors (e.g., Ag, Pd, Cu, Al, or Ni) that are adjacent to but separated from each other in a first direction, and are electrically connected to each other.

### SUMMARY

When an Fe—Si based metal magnetic substance or an Fe—Si—Cr based metal magnetic substance is heated, Fe and Si react with oxygen in the atmosphere and an oxide film is formed on the surfaces of the metal magnetic particles. In this regard, a higher heating temperature for heat-treating a base body containing the metal magnetic substance causes a greater amount of Si component deposited on the surfaces of the metal magnetic particles. The inventor has found that the deposition of the Si component causes deviation from a designed composition of the oxide film, leading to variation and/or decrease in the inductance value (L value).

One solution to the above problem is that the heating temperature is lowered so that the deposition of the Si component is reduced. However, the low heating temperature leads to insufficient sintering of the coil conductor composing the coil disposed in the base body and thus causes generation of pores (cavities) in the coil conductor, resulting in failure to achieve a desired direct-current resistance (R_{dc}).

The present disclosure has been made in view of the above circumstances. That is, the present disclosure provides an inductor which has a reduced amount of Si component deposited and includes a coil conductor having a reduced amount of pores generated therein, and a method of manufacturing the inductor.

An inductor according to the present disclosure includes a base body that internally includes a coil conductor and contains a metal magnetic particle and a resin, the metal magnetic particle being composed of a metal particle containing Fe and Si, and an oxide layer provided on a surface of the metal particle; and an outer electrode that is provided on the base body and is connected to the coil conductor. A peak value of a Si concentration in the oxide layer is less than or equal to twice a Si concentration at a predetermined position in an internal portion of the metal particle, and the coil conductor has a pore proportion of 10% or less.

An inductor manufacturing method according to the present disclosure includes a base body forming step of forming a base body; and an outer electrode forming step of forming an outer electrode on a mounting surface of the base body. The base body forming step includes a layering step of layering a metal magnetic substance and a coil conductor, the metal magnetic substance containing a metal magnetic particle containing Fe and Si; a drying step of drying the base body to cause a peak value of a Si concentration in an oxide layer of the metal magnetic particle to be less than or equal to twice a Si concentration at a predetermined position in an internal portion of a metal particle; a debindering step of debindering the base body after the drying step; and a heat-treating step of heat-treating the base body to cause the coil conductor to have a pore proportion of 10% or less after the debindering step.

According to the present disclosure, an inductor having a reduced amount of Si component deposited and including a coil conductor having a reduced amount of pores generated therein, and a method of manufacturing the inductor can be provided.

### BRIEF DESCRIPTION OF THE DRAWINGS

FIG. 1 is a perspective view of an inductor of the present disclosure;

FIG. 2 is an exploded perspective view of the inductor of the present disclosure;

FIG. 3 is a sectional view taken along line III-III in FIG. 2 as viewed in the direction of the arrows;

FIG. 4 is a sectional view of a modification of the inductor of the present disclosure;

FIG. 5A is an enlarged sectional view of a main part of FIG. 3;

FIG. 5B is an enlarged sectional view of a main part of a conventional inductor;

FIG. 6 is an enlarged sectional view of a main part of FIG. 5A;

FIG. 7A is a graph showing results of composition analysis of metal magnetic particles of the inductor of the present disclosure;

FIG. 7B is a graph showing results of composition analysis of metal magnetic particles of the conventional inductor;

FIG. 8A is a graph showing the distribution of inductance values (nH) of the inductor of the present disclosure;

FIG. 8B is a graph showing the distribution of inductance values (nH) of the conventional inductor; and

FIG. 9 is a manufacturing flowchart for describing the steps of manufacturing the inductor of the present disclosure.

### DETAILED DESCRIPTION

An inductor of the present disclosure will be described below. Note that the present disclosure is not limited to the following configuration, and may be appropriately changed without departing from the gist of the present disclosure. The present disclosure also encompasses a combination of the preferable configurations described below.

The inductor of the present disclosure is used for, for example, a DC-DC converter. The inductor of the present disclosure can also be applied to other uses than the DC-DC converter.

Terms that refer to the relationship between elements (e.g., “parallel”, “orthogonal”, and the like) and terms that refer to the shape of an element are used herein to mean not only literal strict aspects but also a substantially equivalent range, e.g., a range including a difference of about a few percent. Note that the direction in which magnetic layers and coil conductors constituting a base body are layered is herein referred to as a “layering direction”.

In addition, any mention of direction, orientation, or the like herein is merely for the purpose of convenience of description, and is not intended to restrict the scope of the present disclosure, unless otherwise explicitly stated. For example, relative terms such as “outside (or outer side portion, external portion, or outer periphery)” and “inside (or inner side portion, internal portion, or inner periphery)” and terms derived therefrom should be construed to refer to directions described or illustrated herein. That is, such terms do not require the disclosure to be limited only to a specific direction, orientation, configuration, or the like, unless otherwise explicitly stated. The same applies to terms such as “provided”, “disposed”, and “connected”, and terms derived therefrom, including not only a direct mode but also a mode in which another object is interposed, unless otherwise explicitly stated.

The drawings referred to in the following description are schematically illustrated, and their dimensions, scales of aspect ratios, and the like may differ from those of actual products.

### Inductor of the Present Disclosure

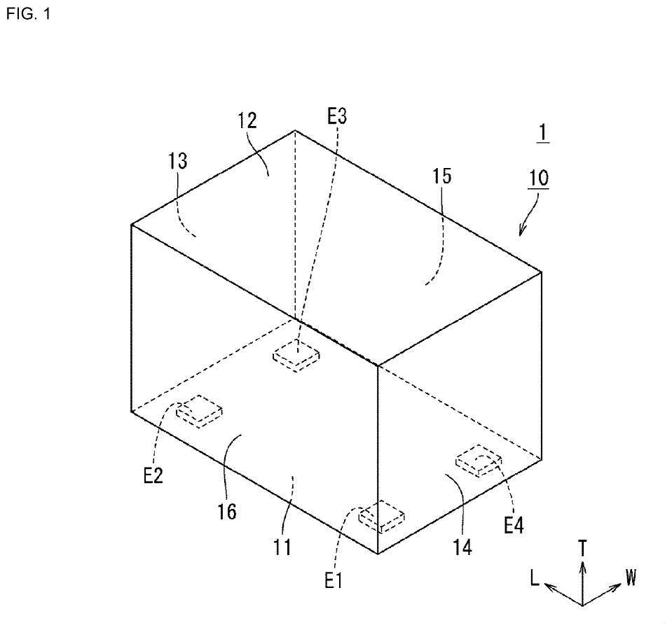

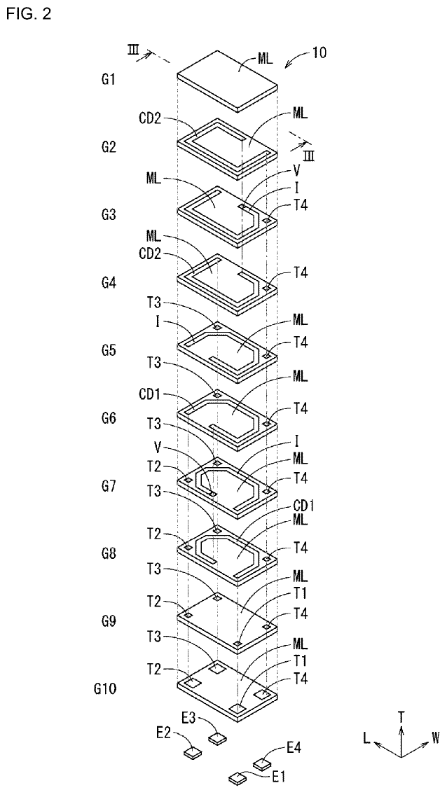

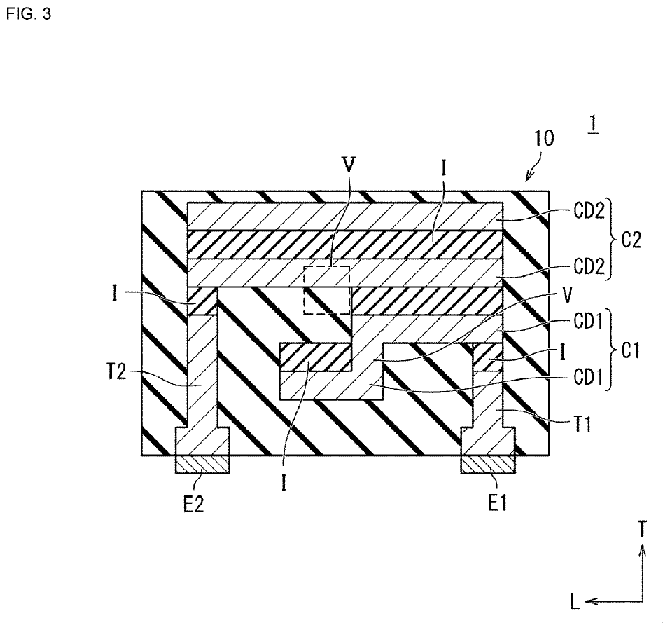

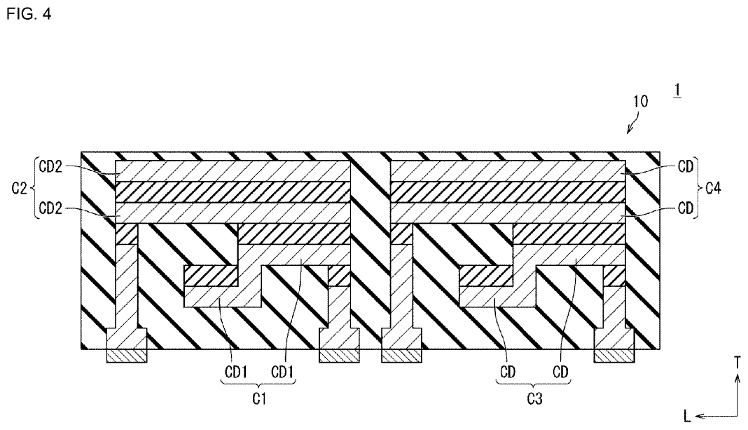

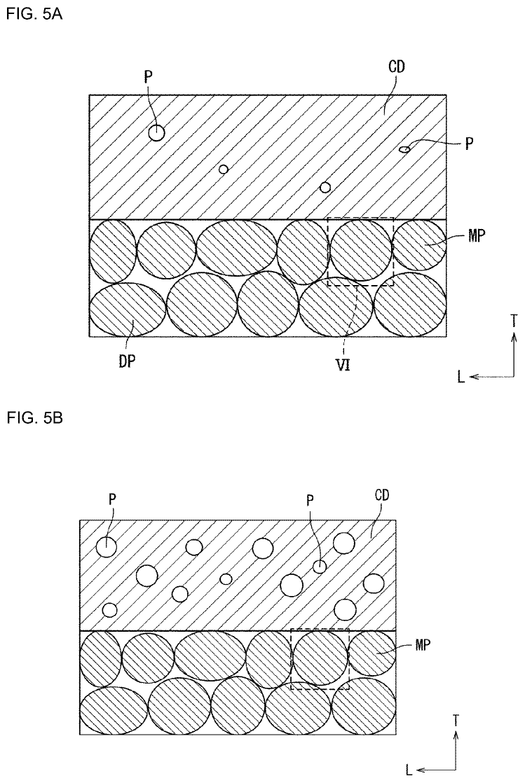

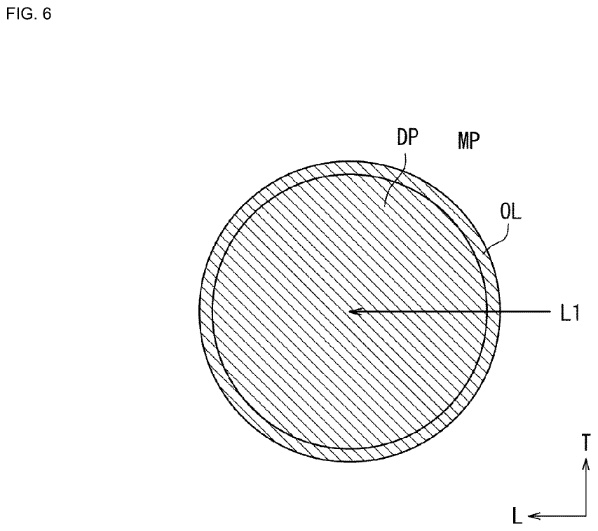

The inductor of the present disclosure will be described with reference to FIGS. 1 to 6. FIG. 1 is a perspective view of the inductor of the present disclosure; FIG. 2 is an exploded perspective view of the inductor of the present disclosure; FIG. 3 is a sectional view taken along line III-III in FIG. 2 as viewed in the direction of the arrows; FIG. 4 is a sectional view of a modification of the inductor of the present disclosure; FIG. 5A is an enlarged sectional view of a main part of FIG. 3; FIG. 5B is an enlarged sectional view of a main part of a conventional inductor; and FIG. 6 is an enlarged sectional view of a main part of FIG. 5A. Note that the shapes, arrangement, and the like of the inductor and respective constituent elements are not limited to those of the illustrated examples.

An inductor 1 of the present disclosure includes: a base body 10 that internally includes a coil conductor CD, and contains metal magnetic particles MP and a resin (not illustrated); and outer electrodes E1 to E4 connected to the coil conductor CD (see FIG. 1). The metal magnetic particles MP are each composed of a metal particle DP containing Fe and Si, and an oxide layer OL provided on the surface of the metal particle DP (see FIG. 6).

In the present embodiment, the base body 10 includes a first coil C1 and a second coil C2 disposed above the first coil C1 in a height direction T (see FIG. 3). The first coil C1 is composed of first coil conductors CD1 spirally wound through a via conductor V (see FIG. 3), which configuration is achieved by layering of a plurality of layering groups G6 and G8 to be described later (see FIG. 2). The second coil C2 is composed of second coil conductors CD2 spirally wound through a via conductor (not illustrated), which configuration is achieved by layering of a plurality of layering groups G2 and G4 to be described later (see FIG. 2).

The configuration of the coil internally provided in the base body 10 is not limited to the above, and the base body 10 may include one coil, or two or more coils. For example, the base body 10 may include four coils C1 to C4 as illustrated in FIG. 4. Specifically, the third coil C3 internally provided in the base body 10 illustrated in FIG. 4 may be disposed in a direction intersecting with the layering direction relative to the first coil C1, and the fourth coil C4 may be disposed in a direction intersecting with the layering direction relative to the second coil C2.

Each of the constituent elements will be described in detail below.

### —Base Body—

The base body 10 has, for example, a rectangular parallelepiped shape or a substantially rectangular parallelepiped shape with six surfaces. The corner portions and the ridge portions of the base body 10 may be rounded. The corner portion refers to a portion where three surfaces of the base body 10 converge, and the ridge portion refers to a portion where two surfaces of the base body 10 converge.

In FIG. 1, the length direction, the width direction, and the height direction of the inductor 1 and the base body 10 are shown as an L direction, a W direction, and a T direction, respectively. The length direction L, the width direction W, and the height direction T are orthogonal to each other. A mounting surface of the inductor 1 is, for example, a surface being parallel to the length direction L and the width direction W (LW surface).

The base body 10 illustrated in FIG. 1 includes: a first principal surface 11 and a second principal surface 12 opposite to each other in the height direction T; a first end surface 13 and a second end surface 14 being opposite to each other in the length direction L which orthogonal to the height direction T; and a first lateral surface 15 and a second lateral surface 16 opposite to each other in the width direction W orthogonal to the length direction L and the height direction T. In the example illustrated in FIG. 1, the first principal surface 11 of the base body 10 corresponds to a mounting surface (bottom surface) of the base body 10. Note that the second principal surface 12 may serve as the mounting surface of the base body 10.

The base body 10 has a multilayer structure including a metal magnetic substance layer ML, a plurality of metal magnetic substance layers ML provided with insulators I and coil conductors CD, and a plurality of metal magnetic substance layers ML provided with insulators I, which are layered in the layering direction (for example, the height direction T). In the present embodiment, the base body 10 includes layering groups G1 to G10 layered together each including at least one metal magnetic substance layer ML and a coil conductor CD (or the metal magnetic substance layer ML alone) as illustrated in FIG. 2. Note that interfaces between the layers of the multilayer structure of the base body 10 are eliminated. Each layer of the layering groups may include a plurality of layers of the same pattern.

### (Layering Group G1)

The layering group G1 has the metal magnetic substance layer ML, and constitutes the second principal surface 12 of the base body 10.

### (Layering Group G2)

The layering group G2 has the metal magnetic substance layer ML, an insulator (not illustrated) provided in the metal magnetic substance layer ML, and the second coil conductor CD2 which is formed on the insulator and constitutes a part of the second coil C2.

The second coil conductor CD2 of the layering group G2 constitutes one spiral of the second coil C2. More specifically, the second coil conductor CD2 is disposed on the insulator formed in the thickness direction of the metal magnetic substance layer ML along a substantially outer peripheral edge of the metal magnetic substance layer ML. One end of the second coil conductor CD2 is connected to the via conductor (not illustrated) for connection to the second coil conductor CD2 provided on an insulator of the metal magnetic substance layer ML of the layering group G4, whereas the other end of the second coil conductor CD2 is connected to a fourth through-hole conductor (not illustrated) for electrical connection to the fourth outer electrode E4.

### (Layering Group G3)

The layering group G3 has the metal magnetic substance layer ML, the insulator I provided in the metal magnetic substance layer ML, a via conductor V provided in the insulator I, and a fourth through-hole conductor T4 provided in the metal magnetic substance layer ML.

The insulator I of the layering group G3 may be provided in correspondence with the spiral shape of the second coil conductor CD2 of the layering group G4 described later. In perspective plan view, the plane area of the insulator I of the layering group G3 may be designed to be larger than the plane area of the second coil conductor CD2 of the layering group G4. The insulator I larger in plane area than the second coil conductor CD2 can provide proper electrical insulation between the coil conductors in the layering direction.

The via conductor V of the layering group G3 is disposed in such a position that allows connection to the one end of the second coil conductor CD2 of the layering group G2.

The fourth through-hole conductor T4 of the layering group G3 connects the fourth through-hole conductors T4 of the layering groups G2 and G4 to each other, which are adjacent thereto in the layering direction, and is electrically connected to the fourth outer electrode E4. Therefore, the fourth through-hole conductor T4 is disposed in a position corresponding to the fourth outer electrode E4 in perspective plan view.

### (Layering Group G4)

The layering group G4 has the metal magnetic substance layer ML, an insulator (not illustrated) provided in the metal magnetic substance layer ML, the second coil conductor CD2 which is formed on the insulator and constitutes a part of the second coil C2, and the fourth through-hole conductor T4 provided in the metal magnetic substance layer ML.

The second coil conductor CD2 of the layering group G4 constitutes another spiral of the second coil C2. More specifically, the second coil conductor CD2 is disposed on the insulator formed in the thickness direction of the metal magnetic substance layer ML along a substantially outer peripheral edge of the metal magnetic substance layer ML. One end of the second coil conductor CD2 is connected to the second coil conductor CD2 provided on the insulator of the metal magnetic substance layer ML of the layering group G2, whereas the other end of the second coil conductor CD2 is connected to a third through-hole conductor (not illustrated) for electrical connection to the third outer electrode E3.

The fourth through-hole conductor T4 of the layering group G4 connects the fourth through-hole conductors T4 of the layering groups G3 and G5 to each other, which are adjacent thereto in the layering direction, and is electrically connected to the fourth outer electrode E4. Therefore, the fourth through-hole conductor T4 may be disposed on a corner portion of the metal magnetic substance layer ML positioned above the fourth outer electrode E4.

### (Layering Group G5)

The layering group G5 has the metal magnetic substance layer ML, an insulator I provided in the metal magnetic substance layer ML, and a third through-hole conductor T3 and the fourth through-hole conductor T4 provided in the metal magnetic substance layer ML.

The insulator I of the layering group G5 is provided in correspondence with the spiral shape of the first coil conductor CD1 of the layering group G6 described later. When the insulator I is larger in plane area than the first coil conductor CD1, the insulator I can provide proper electrical insulation between the first coil C1 and the second coil C2 disposed in the layering direction.

The third through-hole conductor T3 of the layering group G5 connects the third through-hole conductors T3 of the layering groups G4 and G6 to each other, which are adjacent thereto in the layering direction, and is electrically connected to the third outer electrode E3. Therefore, the third through-hole conductor T3 is disposed in a position corresponding to the third outer electrode E3 in perspective plan view.

The fourth through-hole conductor T4 of the layering group G5 connects the fourth through-hole conductors T4 of the layering groups G4 and G6 to each other, which are adjacent thereto in the layering direction, and is electrically connected to the fourth outer electrode E4. Therefore, the fourth through-hole conductor T4 is disposed in a position corresponding to the fourth outer electrode E4 in perspective plan view.

### (Layering Group G6)

The layering group G6 has the metal magnetic substance layer ML, an insulator (not illustrated) provided in the metal magnetic substance layer ML, the first coil conductor CD1 which is formed on the insulator and constitutes a part of the first coil C1, and the third and fourth through-hole conductors T3 and T4 provided in the metal magnetic substance layer ML.

The first coil conductor CD1 of the layering group G6 constitutes one spiral of the first coil C1. More specifically, the first coil conductor CD1 is disposed on the insulator formed in the thickness direction of the metal magnetic substance layer ML along a substantially outer peripheral edge of the metal magnetic substance layer ML. One end of the first coil conductor CDI is connected with a via conductor (not illustrated) for connection to the first coil conductor CD1 provided on an insulator of the metal magnetic substance layer ML of the layering group G7, whereas the other end of the first coil conductor CD1 is connected with a second through-hole conductor (not illustrated) for electrical connection to the second outer electrode E2.

The third through-hole conductor T3 of the layering group G6 connects the third through-hole conductors T3 of the layering groups G5 and G7 to each other, which are adjacent thereto in the layering direction, and is electrically connected to the third outer electrode E3. Therefore, the third through-hole conductor T3 may be disposed in a corner portion of the metal magnetic substance layer ML positioned above the third outer electrode E3.

The fourth through-hole conductor T4 of the layering group G6 connects the fourth through-hole conductors T4 of the layering groups G5 and G7 to each other, which are adjacent thereto in the layering direction, and is electrically connected to the fourth outer electrode E4. Therefore, the fourth through-hole conductor T4 may be disposed in a corner portion of the metal magnetic substance layer ML positioned above the fourth outer electrode E4.

### (Layering Group G7)

The layering group G7 has the metal magnetic substance layer ML, an insulator I provided in the metal magnetic substance layer ML, the via conductor V provided in the insulator I, and a second through-hole conductor T2, the third through-hole conductor T3, and the fourth through-hole conductor T4 provided in the metal magnetic substance layer ML.

The insulator I of the layering group G7 is provided in correspondence with the spiral shape of the first coil conductor CD1 of the layering group G8 described later. In perspective plan view, the plane area of the insulator I of the layering group G7 may be designed to be larger than the plane area of the first coil conductor CD1 of the layering group G8. The insulator I larger in plane area than the first coil conductor CD1 can provide proper electrical insulation between the coil conductors in the layering direction.

The via conductor V of the layering group G7 is disposed in such a position that allows connection to the one end of the first coil conductor CD1 of the layering group G6.

The second through-hole conductor T2 of the layering group G7 connects the second through-hole conductors T2 of the layering groups G6 and G8 to each other, which are adjacent thereto in the layering direction, and is electrically connected to the second outer electrode E2. Therefore, the second through-hole conductor T2 is disposed in a position corresponding to the second outer electrode E2 in perspective plan view.

The third through-hole conductor T3 of the layering group G7 connects the third through-hole conductors T3 of the layering groups G6 and G8 to each other, which are adjacent thereto in the layering direction, and is electrically connected to the third outer electrode E3. Therefore, the third through-hole conductor T3 is disposed in a position corresponding to the third outer electrode E3 in perspective plan view.

The fourth through-hole conductor T4 of the layering group G7 connects the fourth through-hole conductors T4 of the layering groups G6 and G8 to each other, which are adjacent thereto in the layering direction, and is electrically connected to the fourth outer electrode E4. Therefore, the fourth through-hole conductor T4 is disposed in a position corresponding to the fourth outer electrode E4 in perspective plan view.

### (Layering Group G8)

The layering group G8 has the metal magnetic substance layer ML, an insulator (not illustrated) provided in the metal magnetic substance layer ML, the first coil conductor CD1 which is formed on the insulator and constitutes a part of the first coil C1, and the second to fourth through-hole conductors T2 to T4 provided in the metal magnetic substance layer ML.

The first coil conductor CD1 of the layering group G8 constitutes another spiral of the first coil C1. More specifically, the first coil conductor CD1 is disposed on the insulator formed in the thickness direction of the metal magnetic substance layer ML along a substantially outer peripheral edge of the metal magnetic substance layer ML. One end of the first coil conductor CD1 is connected to the first coil conductor CDI provided on the insulator of the metal magnetic substance layer ML of the layering group G6, whereas the other end of the first coil conductor CD1 is connected to a first through-hole conductor (not illustrated) for electrical connection to the first outer electrode E1.

The second through-hole conductor T2 of the layering group G8 connects the second through-hole conductors T2 of the layering groups G7 and G9 to each other, which are adjacent thereto in the layering direction, and is electrically connected to the second outer electrode E2. In addition, the second through-hole conductor T2 may be disposed in a corner portion of the metal magnetic substance layer ML positioned above the second outer electrode E2.

The third through-hole conductor T3 of the layering group G8 connects the third through-hole conductors T3 of the layering groups G7 and G9 to each other, which are adjacent thereto in the layering direction, and is electrically connected to the third outer electrode E3. In addition, the third through-hole conductor T3 may be disposed in a corner portion of the metal magnetic substance layer ML positioned above the third outer electrode E3.

The fourth through-hole conductor T4 of the layering group G8 connects the fourth through-hole conductors T4 of the layering groups G7 and G9 to each other, which are adjacent thereto in the layering direction, and is electrically connected to the fourth outer electrode E4. In addition, the fourth through-hole conductor T4 may be disposed in a corner portion of the metal magnetic substance layer ML positioned above the fourth outer electrode E4.

### (Layering Group G9)

The layering group G9 has a first through-hole conductor T1, the second through-hole conductor T2, the third through-hole conductor T3, and the fourth through-hole conductor T4 in corner portions of the metal magnetic substance layer ML. The areas of the first to fourth through-hole conductors T1 to T4 of the layering groups G1 to G9 in plan view in the layering direction are substantially the same.

### (Layering Group G10)

The layering group G10 has the first to fourth through-hole conductors T1 to T4 which are larger in plane area than the first to fourth through-hole conductors T1 to T4 of the layering group G9 in corner portions of the metal magnetic substance layer ML. The first to fourth through-hole conductors T1 to T4 may function as base electrodes of the outer electrodes E1 to E4. The first to fourth through-hole conductors T1 to T4 of the layering group G10 larger in plane area than the first to fourth through-hole conductors T1 to T4 of the layering group G9 can improve the strength exhibited after mounted.

The first coil conductors CD1 and the second coil conductors CD2 of the respective layering groups may have the same thickness. Examples of a material for the first coil conductors CD1 and the second coil conductors CD2 include metal conductors such as Ag (silver), Cu (copper), Au (gold), and alloys thereof. The first coil conductors CD1 and the second coil conductors CD2 may be formed by applying a conductive paste to the above-described metal magnetic substance layer ML.

Examples of a material for the first to fourth through-hole conductors T1 to T4 and the via conductors include metal conductors such as Ag and Cu. In addition, the type of the material for the first to fourth through-hole conductors T1 to T4 and the via conductors may be the same as or different from that for the above-described first and second coil conductors CD1 and CD2. The through-hole conductors and the via conductors may be formed, for example, by forming a through hole in the above-described metal magnetic substance layer ML and subsequently applying the conductive paste to the inside of the through hole, or alternatively, by applying the conductive paste and subsequently applying the metal magnetic substance layer ML to the outside of the conductive paste.

When the base body 10 has the multilayer structure including the layering groups G1 to G10 as described above, the inductor 1 has a higher degree of freedom in design. For example, in manufacturing the inductor 1 which includes the base body 10 having a bottom surface (the first principal surface 11) provided with the first to fourth outer electrodes E1 to E4, the first coil C1 and the second coil C2 are readily extracted to the bottom surface side. Note that the multilayer structure having the layering groups G1 to G10 may be formed by layering a material constituting the metal magnetic substance layers ML, a material constituting the insulators I, a material constituting the coil conductors CD, materials constituting the through-hole conductors and the via conductors by sequential printing (e.g., screen printing or the like) from the side of the second principal surface 12 or the first principal surface 11 of the base body 10. In this case, the printing may be repeatedly performed for each of the layering groups G1 to G10 until the metal magnetic substance layers ML, the insulators I, the coil conductors, the through-hole conductors, and the via conductors have a desired thickness. Note that the insulator I between the first coil conductors CD1, and the insulator I between the second coil conductors CD2 are not essential elements. That is, the layering groups G3 and G7 are not essential configurations.

The metal magnetic substance layers ML of the layering groups G1 to G10 contain metal magnetic particles MP composed of a magnetic material (see FIGS. 5A and 5B). The metal magnetic particle MP has the metal particle DP, the oxide layer OL, and the resin (see FIG. 6).

The average particle diameter of the metal magnetic particles MP may be preferably 0.2 μm or more and 20 μm or less (i.e., from 0.2 μm to 20 μm), more preferably 2 μm or more and 15 μm or less (i.e., from 2 μm to 15 μm), further preferably 2 μm or more and 10 μm or less (i.e., from 2 μm to 10 μm). With the metal magnetic particles MP having a relatively small average particle diameter as in the above numerical range, the metal particles DP are readily oxidized, which leads to improvement in insulation properties.

The average particle diameter of the metal magnetic particles MP can be measured by the procedure described below. A sample of the inductor is cut to obtain a cross section of the sample. Specifically, the cross section is obtained by cutting the sample along the center portion of the base body and the winding axis of the coil such that the cutting line is orthogonal to the mounting surface and the end surfaces of the base body. The cross section of the sample may be planarized by ion milling or the like. Three random portions in the middle portion of the resulting cross section of the base body 10 were imaged by an SEM (at a magnification of about 1000 times) and subjected to a composition analysis by EDX. By confirming positions of Fe in the captured field of view with reference to the results of the composition analysis by EDX, the metal magnetic particles MP in the SEM image can be located. The confirmed metal magnetic particles MP are analyzed by image analysis software (e.g., WinROOF2021 manufactured by Mitani Corporation), thereby determining equivalent circle diameters of the metal magnetic particles MP. An average value of the equivalent circle diameters is regarded as the average particle diameter of the metal magnetic particles. Note that the average particle diameter herein may mean the average particle diameter D50 (a diameter equivalent to a volume-based cumulative percentage of 50%).

The metal particle DP contains Fe (iron) and Si. More specifically, the metal particle DP may be a particle or an alloy particle containing Fe and Si. Examples of the metal particle DP include particles of an Fe—Si-based alloy, an Fe—Si—Cr (chromium)-based alloy, an Fe—Si—Al (aluminum)-based alloy, an Fe—Si—B (boron)-P (phosphorous)-Cu (copper)-C (carbon)-based alloy, and an Fe—Si—B—Nb (niobium)-Cu-based alloy. The metal particle DP may also contain impurities such as Cr, Mn (manganese), Cu, Ni (nickel), P, S (sulfur), Co (cobalt), and the like which are not intended in the manufacturing. In addition, the metal particle DP may be contained in a magnetic paste, which will be mentioned in detail in the description of the manufacturing method. Therefore, the metal particle DP may contain an element (e.g., Cr, Al, Li (lithium), or Zn (zinc)) added at the time of producing the magnetic paste, which is more susceptible to oxidation than Fe. Since the metal particle DP contains Si, oxidation of the Fe element contained in the metal magnetic particle is inhibited, thereby further improving the permeability of the inductor 1. Note that the resin component contained in the magnetic paste may be eliminated through the heat treatment of the base body, or remain.

The surface of the metal particle DP is covered with an insulation film. The “insulation property” herein refers to a volume resistivity of 1 MΩcm or more. Due to the insulation film covering the surfaces of the metal particles DP, a high insulation property between the metal particles DP can be exhibited. A specific example of the insulation film is the oxide layer OL, as illustrated in FIG. 6. Note that a structure in which an insulating material is provided in an outer side portion than the oxide layer OL illustrated in FIG. 6 may be employed; that is, the metal particles DP may be covered by a non-illustrated insulating material.

The oxide layer OL is a layer produced by oxidation of the metal particle DP. That is, an oxygen element may be contained. The thickness of the oxide layer OL may be preferably 1 nm or more and 50 nm or less (i.e., from 1 nm to 50 nm), more preferably 1 nm or more and 30 nm or less (i.e., from 1 nm to 30 nm), further preferably 1 nm or more and 20 nm or less (i.e., from 1 nm to 20 nm). For example, the thickness of the oxide layer OL covering the surface of the metal particle DP can be determined with reference to a scanning electron microscope (SEM) image or a transmission electron microscope (TEM) image of a cross section of a sample of the inductor, which is obtained by polishing.

For improvement in the strength of the base body 10, the base body 10 composed of the above-described layering groups layered together having subjected to a heat treatment may be impregnated with a resin so that the resin is interposed between the metal magnetic particles MP adjacently bonded to each other by the insulation films. For example, the resin with which the heat-treated base body 10 is to be impregnated may be one or more resins selected from the group consisting of epoxy resins, phenol resins, polyester resins, polyimide resins, polyolefin resins, silicone resins, acrylic resins, polyvinyl butyral resins, cellulose resins, alkyd resins, and the like.

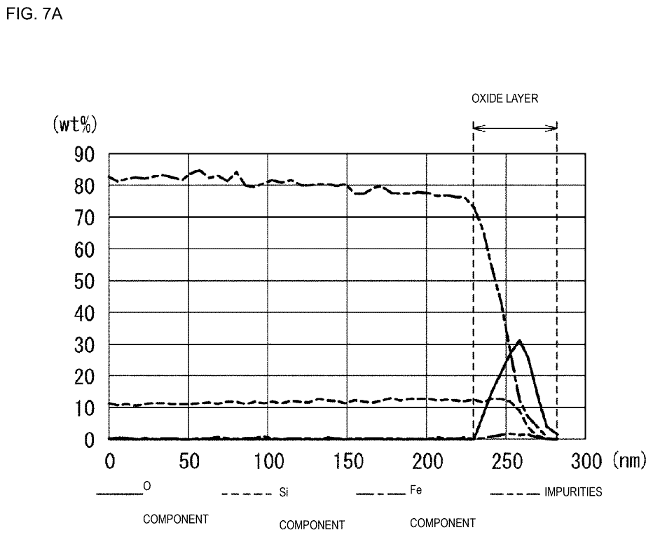

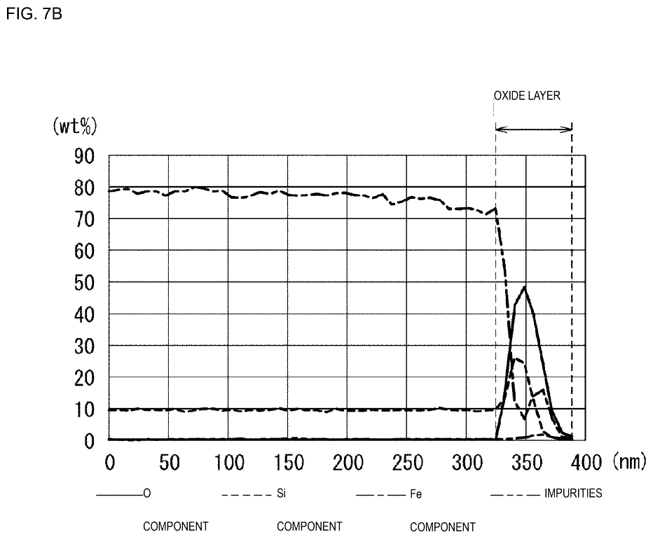

In the inductor 1 of the present embodiment, a peak value of a Si concentration in the oxide layer OL is less than or equal to twice a Si concentration at a predetermined position in an internal portion of the metal particles DP. The Si concentration can be measured by the procedure described below. A sample of the inductor is cut to obtain a cross section of the sample. Specifically, the cross section is obtained by cutting the sample along the center portion of the base body 10 such that the cutting line is orthogonal to the mounting surface (the first principal surface 11) and the end surfaces of the base body 10. More specifically, the cross section is obtained by cutting the sample along the center portion of the base body 10 and the winding axis of the coil C such that the cutting line is orthogonal to the mounting surface and the end surfaces of the base body. The cross section of the sample may be planarized by ion milling or the like. Three random portions in the middle portion of the resulting cross section of the base body 10 are imaged by a TEM (at a magnification of about 400,000 times) and subjected to a composition analysis by EDX, thereby obtaining an average value of the Si concentrations of the metal particles DP at the three portions. In the composition analysis of the metal particles DP by EDX for each position, a line analysis is performed in a direction from the vicinity of an outer edge of the metal magnetic particle MP toward an inside portion of the metal particle DP (the L1 direction in FIG. 6). As one example, a result of the composition analysis shown in FIG. 7A is obtained through the line analysis, although the details of the analysis are described later in EXAMPLES.

The phrase “a peak value of a Si concentration in the oxide layer OL” herein is intended to refer to a maximum value of the Si concentration in the oxide layer OL obtained by the line analysis performed in the direction from the vicinity of an outer edge of the metal magnetic particle MP toward an inside portion of the metal particle DP (the L1 direction in FIG. 6). In addition, the phrase “a Si concentration at a predetermined position in an internal portion of the metal particle DP” herein is intended to refer to the Si concentration at a position in the inside portion of the metal particle DP spaced away by a predetermined distance (e.g., 300 nm) from the position having the peak value of the Si concentration in the oxide layer OL. Note that “the Si concentration” herein is intended to refer to the content, more specifically, the content of Si on the weight basis.

According to the inductor 1 of the present disclosure, since the Si concentration at a predetermined position in the oxide layer OL is less than or equal to twice the Si concentration at a predetermined position in an internal portion of the metal particle DP, deposition of the Si component generated at the time of heating the multilayer body can be reduced, and thus compositional deviation of the oxide layer OL is not likely to occur. Accordingly, degradation in inductance characteristics and the like resulting from the compositional deviation can be reduced.

Although a demonstrative test regarding the peak value of the Si concentration in the oxide layer OL and the Si concentration at a predetermined position in an internal portion of the metal particle DP is described later in detail in EXAMPLES, a preferred inductor of the present disclosure may have a peak value of the Si concentration in the oxide layer OL less than or equal to 1.5 times the Si concentration at a predetermined position in an internal portion of the metal particle DP. More preferably, it may be less than or equal to 1.2 times. Further preferably, it may be less than or equal to one time. With the above-described Si concentration, deposition of the Si component can be further reduced, leading to further reduction in degradation in inductance characteristics and the like. In addition, the risk of discoloration of the base body and/or rusting of the base body caused by compositional deviation can be reduced.

Furthermore, a preferred inductor of the present disclosure may have a Si concentration at a predetermined position in an internal portion of the metal particle DP of 1 wt % or more and 15 wt % or less (i.e., from 1 wt % to 15 wt %) on the basis of the total weight of the metal particle DP. With the above-described Si concentration, deposition of the Si component can be further reduced, leading to further reduction in degradation in inductance characteristics and the like.

The base body 10 internally includes the first coil C1 and the second coil C2. The first and second coils C1 and C2 may be magnetically coupled to each other. For example, the coefficient of coupling between the first and second coils C1 and C2 is 0.1 or more and 0.8 or less (i.e., from 0.1 to 0.8). Note that the base body 10 may internally include two coils including only the first and second coils C1 and C2, or three or more coils including the first and second coils C1 and C2.

### —First Coil—

The first coil C1 is provided in an internal portion of the base body 10. The first coil C1 includes the plurality of first coil conductors CD1 connected to each other through the via conductor V (see FIG. 3), and the first and second through-hole conductors T1 and T2.

The first coil conductor CD1 of the present disclosure has a pore proportion of 10% or less. The pore proportion may be more preferably 7% or less, further preferably 1% or less. The “pores” herein are intended to refer to microsized cavities as illustrated in FIGS. 5A and 5B. Pores P can be observed in an SEM image (for example, an SEM image taken at a magnification of 500 times) of a cross section of a sample of the inductor after a heat treatment, which is obtained by ion milling, as described earlier.

For example, the pore P may have an equivalent circle diameter of about 1 μm as analyzed by image analysis software. The pore P can be more specifically measured by the procedure described below. A sample of the inductor is cut to obtain a cross section of the sample. Specifically, the cross section is obtained by cutting the sample along the center portion of the base body 10 and the winding axis of the coil C such that the cutting line is orthogonal to the mounting surface (the first principal surface 11) and the end surfaces of the base body 10. The cross section of the sample may be planarized by ion milling or the like. An analysis of the resulting cross section through binarization processing for the pores P in the coil conductor CD and conductor portions (e.g., Ag (silver) portions) in the coil conductor CD by image analysis software (WinROOF2021 manufactured by Mitani Corporation) shows that the area proportion of the pores P relative to the entire region observed (for example, a region observed at a magnification of 500 times) is 10% or less. Therefore, the coil conductor CD of the inductor of the present disclosure is sufficiently sintered, so that the pores (cavities) in the coil conductor are reduced. For this reason, the inductor exhibits a desired direct-current resistance (R_{dc}).

The first coil conductor CD1 is a sintered body. Since the first coil conductor CD1 is a sintered body, the sintering of the first coil conductor CD1 can be performed along with the heat treatment of the base body 10, which allows the first coil conductor CD1 to be formed by a simple method.

The sintered body is composed of Ag (silver). Any metal other than Ag may be employed which can be shaped by sintering, and examples thereof include metal conductors such as Cu (copper) and/or Pd (palladium). When Ag is employed as a material for the sintered body, the resistance of the inductor can be further reduced.

The plurality of first coil conductors CD1 are provided in the two layering groups (the layering groups G6 and G8 (see FIG. 2)), as described above. With this configuration, the first coil C1 has a double-layer structure of 1.75 turns. The length in the layering direction of the via conductor V which connects the plurality of first coil conductors CD1 to each other may be shorter than the length of the first through-hole conductor T1 or the second through-hole conductor T2.

The first through-hole conductor T1 electrically connects the first outer electrode E1 to an end portion of the first coil conductor CD1 out of the first coil C1 nearest to the bottom surface (the first principal surface 11) of the base body 10. The first through-hole conductor T1 extends in the layering direction of the metal magnetic substance layers (for example, the height direction T of the base body). The first through-hole conductor T1 may have a multilayer structure.

The second through-hole conductor T2 electrically connects the second outer electrode E2 to the other end portion of the first coil C1. The second through-hole conductor T2 extends in the layering direction of the metal magnetic substance layers (for example, the height direction T of the base body). The second through-hole conductor T2 may have a multilayer structure.

### —Second Coil—

The second coil C2 may be provided in an internal portion of the base body 10 above the first coil C1 in the layering direction. The second coil C2 includes the plurality of second coil conductors CD2 connected to each other through the via conductor (not illustrated), and the third and fourth through-hole conductors T3 and T4.

The second coil conductor CD2 of the present disclosure has a pore proportion of 10% or less. Description regarding pores in the second coil conductor CD2 are similar to that regarding the pores in the first coil conductor CD1, and thus is omitted. The second coil conductor CD2 may be a sintered body, and the sintered body may be composed of Ag. A material for the second coil conductor CD2 may be the same as or different from a material for the first coil conductor CD1.

The plurality of second coil conductors CD2 are provided in the two layering groups (the layering groups G2 and G4 (see FIG. 2)), as described above. With this configuration, the second coil C2 has a double-layer structure of 1.75 turns. The length in the layering direction of the via conductor (not illustrated) which connects the plurality of second coil conductors CD2 to each other may be shorter than the length of the third through-hole conductor T3 or the fourth through-hole conductor T4.

The third through-hole conductor T3 electrically connects the third outer electrode E3 to an end portion of a second spiral out of the second coil C2 nearest to the bottom surface (the first principal surface 11) of the base body 10. The third through-hole conductor T3 extends in the layering direction of the metal magnetic substance layers (for example, the height direction T of the base body). The third through-hole conductor T3 may have a multilayer structure.

The fourth through-hole conductor T4 electrically connects the fourth outer electrode E4 to the other end portion of the second coil C2. The fourth through-hole conductor T4 extends in the layering direction of the metal magnetic substance layers (for example, the height direction T of the base body). The fourth through-hole conductor T4 may have a multilayer structure.

### —Outer Electrode—

The outer electrodes are provided on the bottom surface of the base body 10. The outer electrodes include the first outer electrode E1, the second outer electrode E2, the third outer electrode E3, and the fourth outer electrode E4. The first and second outer electrodes E1 and E2 may be electrically connected to the first coil C1. In addition, the third and fourth outer electrodes E3 and E4 may be electrically connected to the second coil C2. With the outer electrodes provided on the bottom surface (the first principal surface 11) of the base body 10, the inductor 1 can be properly mounted on a mounting substrate or the like.

Examples of a material for the outer electrodes include various materials such as Cu and Ni. The outer electrodes may have one layer, or a multilayer structure of two or more layers. The outer electrodes may be formed by any method, and for example, the outer electrodes may be plated electrodes formed by plating (e.g., electroless plating).

According to the inductor 1 of the present embodiment, since the peak value of the Si concentration in the oxide layer OL illustrated in FIG. 6 is less than or equal to twice the Si concentration at a predetermined position in an internal portion of the metal particle DP and the coil conductor CD has a pore proportion of 10% or less as illustrated in FIG. 5A, deposition of the Si component is reduced and pores generated in the coil conductor are reduced, as described above. Therefore, deposition of the Si component generated at the time of heating the base body can be reduced, and compositional deviation of the oxide film is not likely to occur. This can reduce degradation in inductance characteristics and the like resulting from the compositional deviation. Furthermore, the coil conductor CD disposed in the base body 10 can be sufficiently sintered and thus the pores P generated in the coil conductor CD can be reduced, and therefore, a desired direct-current resistance (R_{dc}) can be exhibited.

### Method of Manufacturing Inductor of Present Disclosure

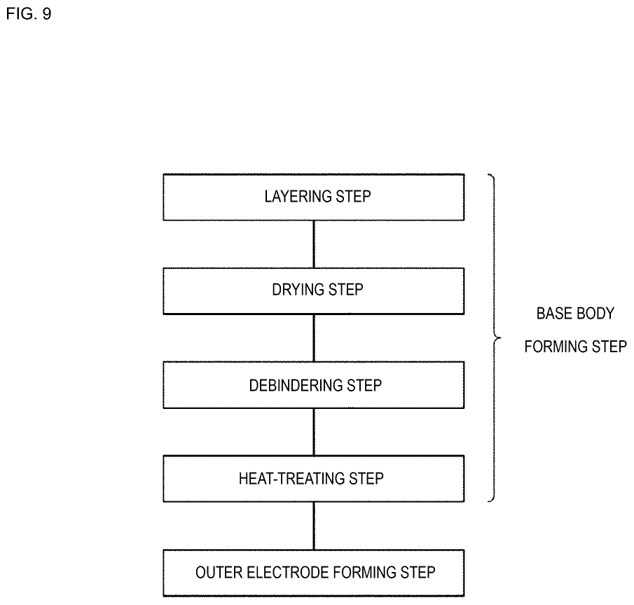

A method of manufacturing the inductor of the present disclosure will be described below with reference to FIG. 9. The method of manufacturing the inductor of the present disclosure includes a base body forming step and an outer electrode forming step.

### —Base Body Forming Step—

The base body forming step includes a layering step, a drying step, a debindering step, and a heat-treating step.

### Layering Step

First, a magnetic paste which constitutes the metal magnetic substance layers ML of the layering groups described with reference to FIG. 2, a conductor paste which constitutes the coil conductors CD, and an insulating paste which constitutes the insulators I between the coil conductors CD are prepared.

As one example of a method of producing the magnetic paste, metal powder such as an Fe—Si alloy or an Fe—Si—Cr alloy the D50 of which is 2 μm or more and 20 μm or less (i.e., from 2 μm to 20 μm) is prepared, the D50 representing a volume-based cumulative 50% particle diameter. To the metal powder are added a binder such as cellulose or polyvinyl butyral (PVB), and a solvent such as a mixture of terpineol and butyl diglycol acetate (BCA), followed by kneading, thereby producing the magnetic paste.

In the case where the Fe—Si alloy is employed as the metal magnetic substance, the content of Si is preferably 2.0 at % or more and 8.0 at % or less (i.e., from 2.0 at % to 8.0 at %). In the case where the Fe—Si—Cr alloy is employed as the metal magnetic powder, the content of Si is preferably 2.0 at % or more and 8.0 at % or less (i.e., from 2.0 at % to 8.0 at %). In the case where the Fe—Si—Cr alloy is employed as the metal magnetic powder, the content of Cr is preferably 0.2 at % or more and 6.0 at % or less (i.e., from 0.2 at % to 6.0 at %).

As one example of a method of producing the insulating paste, Fe₂O₃, ZnO, and CuO are prepared. To the powder containing the above raw materials are added predetermined amounts of a solvent (ketone solvent, etc.), a resin (polyvinyl acetal, etc.), a plasticizer (alkyd plasticizer, etc.), and the like, followed by kneading, thereby producing the insulating paste. Note that the insulating paste may contain any of non-magnetic ferrite powder, alumina powder, glass powder, zirconia powder, and metal magnetic powder having an average particle diameter smaller than that of the metal magnetic powder constituting the base body.

Prepared as the conductor paste is, for example, a paste containing Ag as a conductive material.

The layering groups G1 to G10 illustrated in FIG. 2 are prepared by applying the magnetic paste, the insulating paste, and the conductor paste described above by screen printing or the like, thereby forming a base body composed of the layering groups layered together.

### Drying Step

The drying step is a step of reducing the moisture in the base body by drying, which is formed in the layering step. Although the drying step serves as a factor for achieving the peak value of the Si concentration in the oxide layer of the metal magnetic particle being less than or equal to twice the Si concentration at a predetermined position in an internal portion of the metal particle in the inductor of the present disclosure, the above relationship regarding the Si concentration is achieved not necessarily solely by the drying step, and may be achieved in combination with another step.

As a preferable drying step, the drying step may be performed at a temperature lower than a treatment temperature of the debindering step described later. For example, the base body 10 may be dried at a temperature of about 150° C. or more and 200° C. or less (i.e., from 150° C. to 200° C.) for 10 hours or more. With such drying conditions, the peak value of the Si concentration in the oxide layer OL of the metal magnetic particle MP can be less than or equal to twice the Si concentration at a predetermined position in the internal portion of the metal particle DP.

### Debindering Step

The debindering step is a step of debindering the base body after the drying step. For example, the debindering is performed at a temperature of about 300° C. or more and 500° C. or less (i.e., from 300° C. to 500° C.). With this process, binders contained in the magnetic paste and the conductive paste are removed.

### Heat-Treating Step

Heat treatment is performed after the debindering step. The temperature for the heat treatment is such a temperature that causes the coil conductors to be sintered, for example, a temperature of about 700° C. or more and 900° C. or less (i.e., from 700° C. to 900° C.). The heat-treating step of the present disclosure may be performed in the air atmosphere, or in a low oxygen atmosphere.

For improvement in the strength of the base body, the base body may be impregnated with a resin, followed by curing. Although the resin with which the base body is impregnated is an epoxy resin, one or more resins selected from the group consisting of phenol resins, polyester resins, polyimide resins, polyolefin resins, silicone resins, acrylic resins, polyvinyl butyral resins, cellulose resins, alkyd resins, and the like may be used. The base body of the inductor of the present disclosure is formed through the above steps.

### Outer Electrode Forming Step

The outer electrode forming step is a step of forming the outer electrodes to be electrically connected to the coil conductors. The outer electrodes are formed by electrolytic plating on the mounting surface (the first principal surface 11) of the base body 10 where the through-hole conductors are exposed. A plating material may be Cu. Other non-limiting examples include Ni—Sn, Ni—Au, Ni—Cu and/or Cu—Ni—Au. The resulting element is cut into individual pieces after the outer electrodes are formed, thereby manufacturing the inductors of the present embodiment.

According to the method of manufacturing the inductor in the present embodiment as described above, a method of manufacturing the inductor which has a reduced amount of Si component deposited and includes a coil conductor having a reduced amount of pores generated therein can be provided.

### EXAMPLES

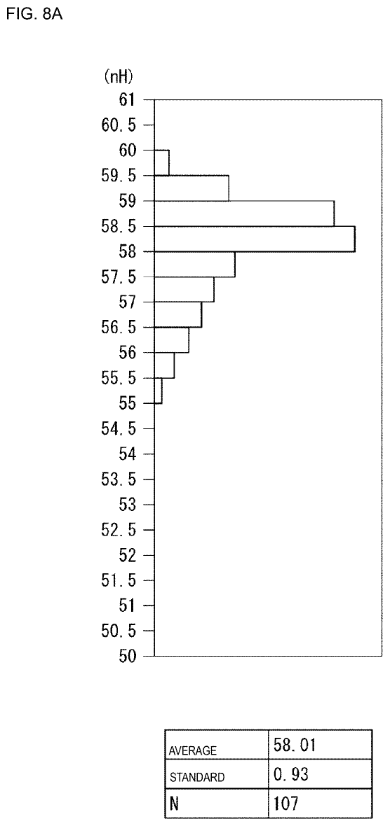

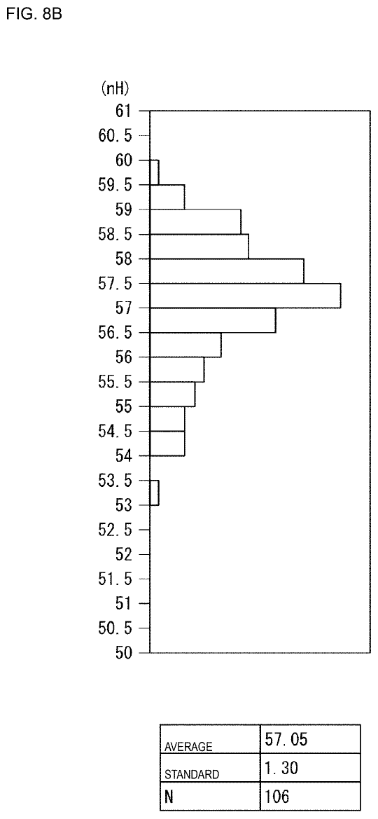

The demonstrative test regarding the inductor of the present disclosure will be described in detail with reference to FIGS. 7A, 7B, 8A, and 8B. Specifically, the metal magnetic particles were subjected to a composition analysis, the pore proportion of the coil conductor was measured, and the distribution of inductance values was measured, regarding Example and Comparative Example below.

### Example

An inductor was manufactured through the above-described base body forming step including the layering step, the drying step, the debindering step, and the heat-treating step, and the above-described outer electrode forming step. Although the heat treatment in the heat-treating step of Example herein was performed in the air atmosphere, deposition of the Si component and pores generated in the coil conductor were further reduced in the case of a heat treatment in a low oxygen atmosphere as compared to the case of the heat treatment in the air atmosphere.

### Comparative Example

An inductor was manufactured through the above-described base body forming step including the layering step, the debindering step, and the heat-treating step, and the above-described outer electrode forming step. That is, the drying step was omitted in Comparative Example, and the heat treatment in the heat-treating step was performed in the air atmosphere.

### —Results of Composition Analysis—

The composition analysis was performed by the method described earlier. That is, a cross section of a sample of the inductor obtained by cutting the sample was subjected to the line analysis in the direction from the vicinity of an outer edge of the metal magnetic particle MP toward an inside portion of the metal particle DP (the L1 direction in FIG. 6) with use of a TEM by EDX. Through the above analysis, “the peak value of the Si concentration in the oxide layer OL” and “the Si concentration at a predetermined position in an internal portion of the metal particle DP” herein were measured.

The inductor of Example had a peak value of the Si concentration in the oxide layer OL of 12 wt %, and a Si concentration at a predetermined position in an internal portion of the metal particle DP (at a position in an inside portion of the metal particle DP spaced away by 300 nm from the position having the peak value of the Si concentration in the oxide layer OL) of 12 wt % (see FIG. 7A), according to the results of analysis of values close to an average of three random portions in the middle portion of the base body 10 on the cross section of the sample of the inductor. In addition, the peak value of the Si concentration in the oxide layer OL was able to be adjusted to be 14.4 wt %, 18 wt %, or 24 wt % by controlling conditions of the drying step and the heat-treating step, with the Si concentration at a predetermined position in the internal portion of the metal particle DP (at the position in the inside portion of the metal particle DP spaced away by 300 nm from the position having the peak value of the Si concentration in the oxide layer OL) fixed to be 12 wt %. This means that the peak value of the Si concentration in the oxide layer OL was able to be adjusted within a range of one to two times the Si concentration at a predetermined position in an internal portion of the metal particle DP. On the other hand, the inductor of Comparative Example had a peak value of the Si concentration in the oxide layer OL of 9 wt %, and a Si concentration at a predetermined position in an internal portion of a metal particle DP (at a position in an inside portion of the metal particle DP spaced away by 300 nm from the position having the peak value of the Si concentration in the oxide layer OL) of 24.3 wt %, according to the results of analysis of values close to an average of three random portions in the middle portion of the base body 10 on the cross section of the sample of the inductor (see FIG. 7B). That is, the peak value of the Si concentration in the oxide layer OL was more than twice the Si concentration at a predetermined position in an internal portion of the metal particle DP.

### —Results of Measurement of Pore Proportion—

The pore proportion was measured by analyzing the cross section of the sample of the inductor obtained by cutting the sample through binarization processing by image analysis software (WinROOF2021 manufactured by Mitani Corporation), as described earlier.

In the inductor of Example, the pore proportion of the coil conductor CD was 10% or less, as illustrated in FIG. 5A. On the other hand, in the inductor of Comparative Example, the coil conductor CD was insufficiently sintered, and the pore proportion of the coil conductor CD was more than 16%, as illustrated in FIG. 5B.

### —Measurement of Distribution of Inductance Values—

In the measurement of distribution of the inductance values, inductances at a measurement frequency of 10 MHz were measured with an LCR meter (E4982A, manufactured by Keysight Technologies).

In the inductor of Example, the average of inductance values was 58.01 nH and the standard deviation thereof was 0.93, in which the total number of samples was 107, as shown in FIG. 8A. On the other hand, in the inductor of Comparative Example, the average of inductance values was 57.05 nH and the standard deviation thereof was 1.30, in which the total number of samples was 106, as shown in FIG. 8B. According to the measurement of distribution of inductance values, the inductor of Example was improved in the inductance value and also in variation in the inductance values, as compared to the inductor of Comparative Example.

Note that the embodiment disclosed herein is illustrative in all aspects, and does not constitute grounds for limited interpretations. Accordingly, the technical scope of the present disclosure should be construed not on the basis of the foregoing embodiment, but on the claims. In addition, all changes which come within the meaning and range of equivalency of the claims fall within the technical scope of the present disclosure. Although the base body 10 having the layering groups G1 to G10 is disclosed as an example, the insulators I are not essential components. In the case where the insulators I are omitted, the layering groups G3 and G7 may be omitted. Although an aspect in which the surface of the metal particle DP is covered by the oxide layer OL is disclosed in FIG. 6, such an aspect is not restrictive; for example, the oxide layer OL may be further covered by an insulating material.

Aspects of the inductor of the present disclosure and the method of manufacturing the inductor are as follows.
<1> An inductor including a base body that internally includes a coil conductor and contains a metal magnetic particle and a resin, the metal magnetic particle being composed of a metal particle containing Fe and Si, and an oxide layer provided on a surface of the metal particle; and an outer electrode that is provided on the base body and is connected to the coil conductor. A peak value of a Si concentration in the oxide layer is less than or equal to twice a Si concentration at a predetermined position in an internal portion of the metal particle, and the coil conductor has a pore proportion of 10% or less.
<2> The inductor according to <1>, in which the peak value of the Si concentration in the oxide layer is less than or equal to 1.5 times the Si concentration at the predetermined position in the internal portion of the metal particle.
<3> The inductor according to <1> or <2>, in which the coil conductor is a sintered body.
<4> The inductor according to <3>, in which the sintered body contains Ag as a component.
<5> The inductor according to any one of <1> to <4>, in which an average particle diameter D50 of the metal magnetic particle is 0.2 μm or more and 20 μm or less (i.e., from 0.2 μm to 20 μm).
<6> The inductor according to any one of <1> to <5>, in which the Si concentration at the predetermined position in the internal portion of the metal particle is 1 wt % or more and 15 wt % or less (i.e., from 1 wt % to 15 wt %) on the basis of a total weight of the metal particle.
<7> An inductor manufacturing method including a base body forming step of forming a base body; and an outer electrode forming step of forming an outer electrode on a mounting surface of the base body. The base body forming step includes a layering step of layering a metal magnetic substance and a coil conductor, the metal magnetic substance containing a metal magnetic particle containing Fe and Si; a drying step of drying the base body to cause a peak value of a Si concentration in an oxide layer of the metal magnetic particle to be less than or equal to twice a Si concentration at a predetermined position in an internal portion of a metal particle; a debindering step of debindering the base body after the drying step; and a heat-treating step of heat-treating the base body to cause the coil conductor to have a pore proportion of 10% or less after the debindering step.
<8> The inductor manufacturing method according to <7>, in which the drying step is performed at a temperature lower than a treatment temperature in the debindering step.
<9> The inductor manufacturing method according to <7> or <8>, in which the heat-treating step is performed at a temperature higher than a treatment temperature in the debindering step.

The inductor of the present disclosure can be suitably used as an electronic component which has a reduced amount of Si component deposited and includes a coil conductor having a reduced amount of pores generated therein.

What is claimed is:

1. An inductor comprising:
a base body that internally includes a coil conductor and includes a metal magnetic particle and a resin, the metal magnetic particle including a metal particle including Fe and Si, and an oxide layer on a surface of the metal particle; and
an outer electrode that is on the base body and is connected to the coil conductor, wherein
a peak value of a Si concentration in the oxide layer is less than or equal to twice a Si concentration at a predetermined position in an internal portion of the metal particle, and the coil conductor has a pore proportion of 10% or less.

2. The inductor according to claim 1, wherein
the peak value of the Si concentration in the oxide layer is less than or equal to 1.5 times the Si concentration at the predetermined position in the internal portion of the metal particle.

3. The inductor according to claim 1, wherein
the coil conductor is a sintered body.

4. The inductor according to claim 3, wherein
the sintered body includes Ag as a component.

5. The inductor according to claim 1, wherein
an average particle diameter D50 of the metal magnetic particle is from 0.2 μm to 20 μm.

6. The inductor according to claim 1, wherein
the Si concentration at the predetermined position in the internal portion of the metal particle is from 1 wt % to 15 wt % on the basis of a total weight of the metal particle.

7. The inductor according to claim 2, wherein
the coil conductor is a sintered body.

8. The inductor according to claim 7, wherein
the sintered body includes Ag as a component.

9. The inductor according to claim 2, wherein
an average particle diameter D50 of the metal magnetic particle is from 0.2 μm to 20 μm.

10. The inductor according to claim 3, wherein
an average particle diameter D50 of the metal magnetic particle is from 0.2 μm to 20 μm.

11. The inductor according to claim 4, wherein
an average particle diameter D50 of the metal magnetic particle is from 0.2 μm to 20 μm.

12. The inductor according to claim 2, wherein
the Si concentration at the predetermined position in the internal portion of the metal particle is from 1 wt % to 15 wt % on the basis of a total weight of the metal particle.

13. The inductor according to claim 3, wherein
the Si concentration at the predetermined position in the internal portion of the metal particle is from 1 wt % to 15 wt % on the basis of a total weight of the metal particle.

14. The inductor according to claim 4, wherein
the Si concentration at the predetermined position in the internal portion of the metal particle is from 1 wt % to 15 wt % on the basis of a total weight of the metal particle.

15. The inductor according to claim 5, wherein
the Si concentration at the predetermined position in the internal portion of the metal particle is from 1 wt % to 15 wt % on the basis of a total weight of the metal particle.

16. The inductor according to claim 7, wherein
the Si concentration at the predetermined position in the internal portion of the metal particle is from 1 wt % to 15 wt % on the basis of a total weight of the metal particle.

17. An inductor manufacturing method comprising:
forming a base body; and
forming an outer electrode on a mounting surface of the base body, wherein
the forming of a base body includes:
layering a metal magnetic substance and a coil conductor, the metal magnetic substance including a metal magnetic particle including Fe and Si;
drying the base body to cause a peak value of a Si concentration in an oxide layer of the metal magnetic particle to be less than or equal to twice a Si concentration at a predetermined position in an internal portion of a metal particle;
debindering the base body after the drying; and
heating the base body to cause the coil conductor to have a pore proportion of 10% or less after the debindering.

18. The inductor manufacturing method according to claim 17, wherein
the drying is performed at a temperature lower than a treatment temperature in the debindering.

19. The inductor manufacturing method according to claim 17, wherein
the heating is performed at a temperature higher than a treatment temperature in the debindering.

20. The inductor manufacturing method according to claim 18, wherein
the heating is performed at a temperature higher than a treatment temperature in the debindering.
